(19) United States
(12) Patent Application Publication
(10) Pub. No.: US 2009/0167838 A1
(43) Pub. Date: Jul. 2, 2009

(54) METHOD AND APPARATUS FOR CLEANING A TELEMEDICINE STATION

(76) Inventors: David I. Poisner, Carmichael, CA (US); Kenny B. Bailey, Folsom, CA (US)

Correspondence Address: SCHWEGMAN, LUNDBERG & WOESSNER, P.A., P.O. BOX 2938, MINNEAPOLIS, MN, 55402, US

(21) Appl. No.: 11/967,986

(22) Filed: Dec. 31, 2007

(51) Int. Cl. H04N 7/14

(52) U.S. Cl. 348/14.04; 348/E07.077

(57) ABSTRACT

Apparatus and method for cleaning a telemedicine booth include identifying a custodian in the booth, providing visual and/or audio prompting or instructions on cleaning the booth, receiving input from the custodian regarding the status of the cleaning performed on the booth, and transmitting information regarding the cleaning of the booth to a remote computer system. The method and apparatus further include providing an ultra-violet light source in the booth and activating the light source to reduce the growth of harmful bacteria, or kill bacteria. An alert/notification may be sent to a custodian that the booth needs or could use cleaning.

### TECHNICAL FIELD

The present invention generally relates to the field of providing medical services to users located remotely from medical service providers.

### BACKGROUND

Advances in computing and communications technology have allowed increasing remote operations in many fields. Among other fields, these technologies have enabled the remote provision of medical services to locations where a user may not have immediate in-person access to a medical services professional.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a block diagram of a system for routing a medical service request according to an embodiment of the inventive subject matter.

FIGS. 2A, 2B and 2C are schematic illustrations of a telemedicine station according to an embodiment of the inventive subject matter.

FIG. 2D is a perspective view of a telemedicine station according to an embodiment of the inventive subject matter.

FIG. 2E is a schematic illustration of a telemedicine station including a ultra-violet light according to an embodiment of the inventive subject matter.

FIG. 3 is a schematic illustration of a routing agent according to an embodiment of the inventive subject matter.

FIG. 4 is a flowchart of a method for routing a medical service request according to an embodiment of the inventive subject matter.

FIG. 5 is a flowchart of a method for cleaning a remote medical station according to an embodiment of the inventive subject matter.

FIG. 6 is a flowchart of a method for cleaning a remote medical station according to an embodiment of the inventive subject matter.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION

In the following detailed description, numerous specific details are set forth in order to provide a thorough understanding of the inventive subject matter. However it will be understood by those of ordinary skill in the art that the present invention may be practiced without these specific details. In other instances, well-known methods, procedures, components and circuits have not been described in detail so as not to obscure the inventive subject matter. Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the system's registers and/or memories into other data similarly represented as physical quantities within the system's memories, registers or other such information storage, transmission or display devices. In addition, the term “plurality” may be used throughout the specification to describe two or more components, devices, elements, parameters and the like.

According to the various embodiments presented, the inventive subject matter described herein provides method and apparatus for cleaning a telemedicine station or booth. Such a telemedicine station or booth, as described in detail below, may include a private space that a patient may use to engage in a private consultation with remote medical personnel using one or more telecommunications capabilities of the station or booth. Optionally, the booth may include one or more instruments to obtain physiological measurements from the patient, for example heart rate or blood pressure. According to various embodiments described further herein below, the inventive subject matter provides for effective, timely cleaning of such a telemedicine station or booth, the unambiguous identification of the custodian performing cleaning services, accurate and unambiguous records of cleaning activities, and for minimizing the need to train custodians to perform the cleaning operations.

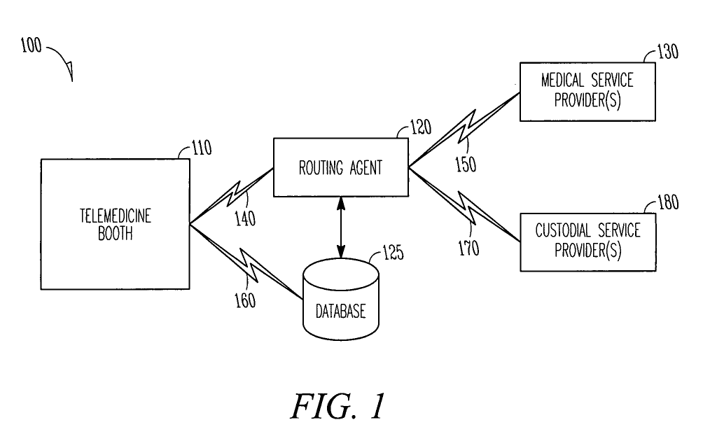

Reference is now made to FIG. 1 which shows a telemedicine station or booth 110 according to the inventive subject matter that may be for example an enclosure or enclosed booth capable of operations required for routing a user's request for medical service. Other structures or stations, such as a set of components mounted to an open or not enclosed structure, may be used. These operations may include for example authenticating a user identification, authorizing a user for payment, capturing user medical parameters, contacting a routing agent, sending captured medical parameters to the routing agent, and enabling the user to communicate with a medical services provider. In some embodiments, telemedicine booth 110 may also be capable of dispensing medicine or prescriptions as directed by the medical services provider. Telemedicine booth 100 may also be capable of other operations associated with routing a user's request for medical service. A routing agent 120 may be a system or device capable of collecting a user's medical parameters from telemedicine booth 110, routing the user's request for medical services to a medical services provider, and establishing a link between the user and a medical services provider such as medical services provider 130. Routing agent 120 may also be capable of or assist in authenticating the identity of a user in telemedicine booth 110 and/or authorizing a user to use system 100. Routing agent 120 may be or include a computer, computerized systems, or other equipment and may be operated, monitored, or staffed by for example a healthcare consultant or other personnel trained to route medical service requests using the resources of routing agent 120. In some embodiments, routing agent 120 may include a terminal or equipment for use by a healthcare consultant to communicate with telemedicine booth 110, a user in telemedicine booth 110, and/or one or more medical service providers 130. Other equipment and functions may also be provided.

In some embodiments, telemedicine booth 110 may be able to initiate a communications link 140 with routing agent 120. Communications link 140 may be one or more of an audio link, a video or videoconference link, and/or a data link and may utilize one or more of a wired, wireless, cellular telephone, or satellite medium as known in the art. Activation of communications link 140 may be initiated by the user or as a result of a process, procedure, or operation such as the user entering telemedicine booth 110, entry of a credit card or identification card, or confirmation of payment. Other operations for activating communication link 140 may also be used.

Using communications link 140, user information from telemedicine booth 110 may be transferred to routing agent 120. In some embodiments, information may be transferred as a result of data captured from the user such as for example medical parameters or identification at telemedicine booth 110 or by a conversation on for example an audio or video link or a text communication link. Other techniques for transferring user information from telemedicine booth over communications link 140 may also be used. In some embodiments, information transfer over communications link 140 may also be two-way to enable routing agent 120 to provide instructions, to ask questions, or provide other information to a user in telemedicine boot 110.

Routing agent 120 and/or telemedicine booth 110 may be connected locally or remotely to one or more databases 125 for storing records. Database 125 may be or include any suitable software process or application and memory for storing and retrieving information, files, or a plurality of documents, such as a database system such as, e.g., a relational database. Items stored in database 125 may include for example personal data regarding identity, patient medical records, credit or payment status, and or other records related to the provision of medical services for users and/or patients. Additional items stored in database 125 may include information on medical service providers such as, for example, location, medical specialty, availability, fees, ratings, and the like. In some embodiments, different categories of information such as, e.g., user records and medical service provider records may be stored in a number of databases 125. Routing agent 120 may use information stored in one or more databases 125 for one or more of verifying a user's identity, credit or payment, and/or routing a user's request for medical service to a medical service provider or medical agent. In some embodiments, telemedicine booth 110 may establish a communications link 160 with database 125 directly for authenticating a user's identity and/or authorizing a user's payment type, e.g. credit card, debit card, or account based payment. In some embodiments, medical service provider 130 may establish a communication link with database 125 for accessing a user's personal information, medical records, or medical parameters.

Database 125 may include a record keeping system for access to medical records such as, e.g., retrieving or updating medical records. Such a record keeping system may include activity logging to comply with relevant patient privacy or other requirements or regulations and may for example record the name of agents and/or medical service providers, time of access, type of access, and the like.

In some embodiments, routing agent 120 may, with user information collected from telemedicine booth 110 and one or more databases 125 and with medical service provider information collected from one or more databases 125 determine one or more medical service providers 130 of a plurality of medical service providers to which a user's request for medical service should be routed or connected. Routing agent 120 may establish a communications link 150 between routing agent 120 and medical service provider 130 by possibly the same or different communications technology as that for communications link 140. In some embodiments communications link 150 may also have the same capabilities for data transfer and two-way communications as communications link 140; however in other embodiments the links may differ in type and capability. Once communications link 150 is established, routing agent 120 may, in some embodiments, transfer communications link 150 to telemedicine booth 110, connect communication links 140 and 150, or establish a separate direct link between telemedicine booth 110 and medical service provider 130.

Medical service provider 130 may be or include a licensed medical service professional such as for example a doctor, nurse, nurse-practitioner, or dentist who is available to accept a request for medical service from a user at telemedicine booth 110 and provide a medical consultation via a communication link established by routing agent 120 between medical service provider 130 and telemedicine booth 110. Other providers may be used, depending on need, licensing, or convention. User information captured at telemedicine booth 110 and/or retrieved from database 125 may be transferred to medical service provider 130 before or during a medical consultation. Medical service provider 130 may be capable of and authorized to dispense medicine, prescriptions, and/or directions for care remotely to a user at telemedicine booth 110.

According to another embodiment, routing agent 120 may establish a communications link 170 between routing agent 120 and a custodial service provider 180 by possibly the same or different communications technology as that for communications link 140. In some embodiments communications link 170 may also have the same capabilities for data transfer and two-way communications as communications link 140; however in other embodiments the links may differ in type and capability. As described in more detail below, communication link 170 allows routing agent 120 to send notifications and alerts to a custodial service provider 180.

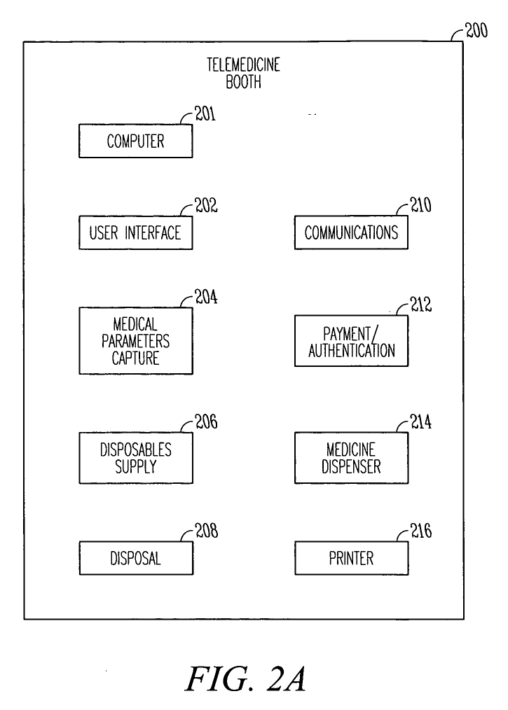

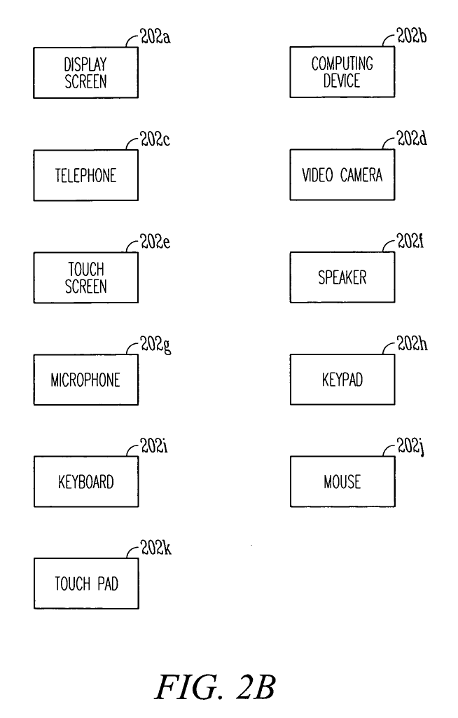

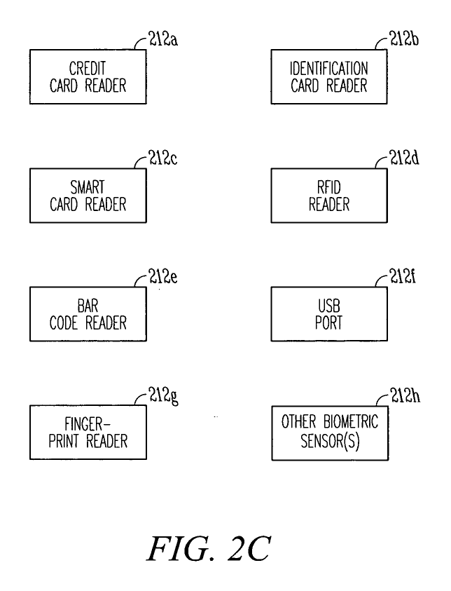

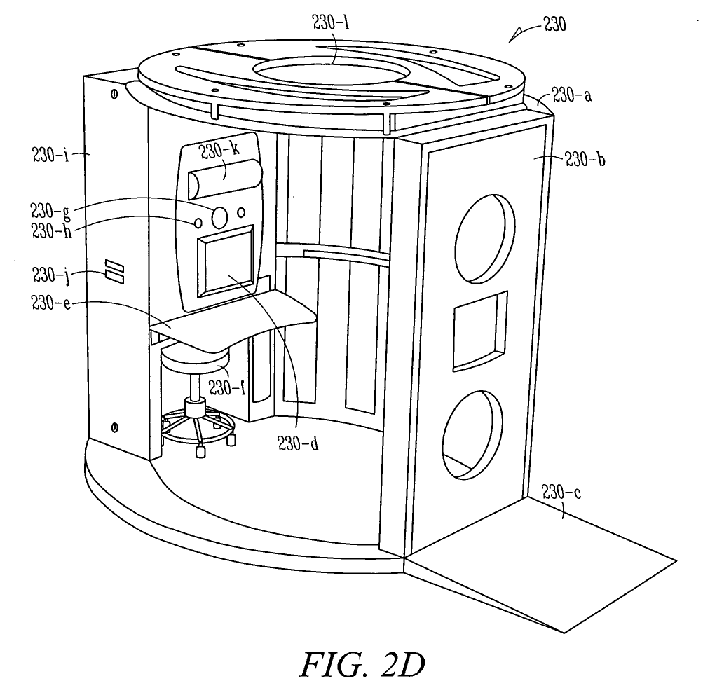

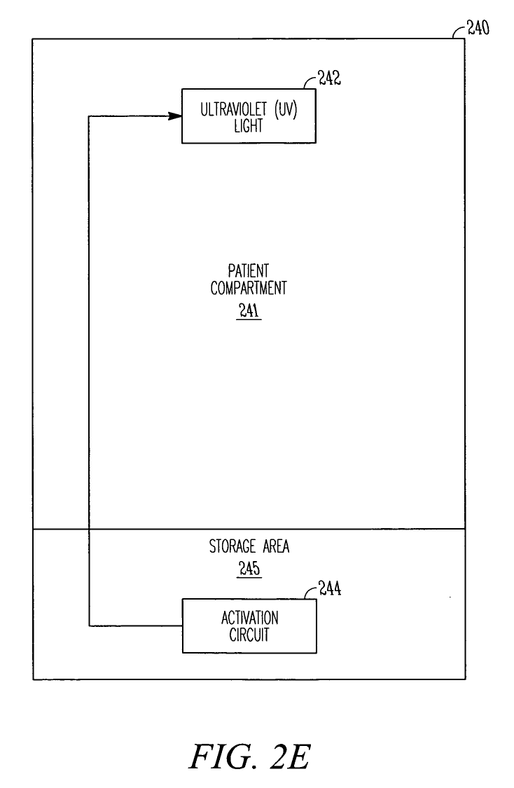

Reference is now made to FIG. 2A, which illustrates a telemedicine station or booth 200 according to an embodiment of the inventive subject matter. Telemedicine booth 200 may be the same as telemedicine booth 110 of the embodiment of FIG. 1 and may include for example a computing system 201, for example a personal computer or workstation, a user interface 202, a medical parameters capture system 204, a disposables supply 206, a disposal system 208, a communications system 210, a payment/authentication system 212, a medicine dispenser 214, and a printer 216. Other systems, devices, and/or components may also be included. Further, medical parameter capture system 204 may include various devices for measuring patient vital signs, such as blood pressure and pulse. Telemedicine booth 200 may be a complete enclosure with a closable door that may allow a user to have privacy during a medical consultation. Furthermore, telemedicine booth 200 may be self contained and or capable of being placed in a number of locations such as for example in a shopping mall, work location, village, and other remote locations. In other embodiments, telemedicine station or booth 200 need not be an enclosed structure.

User interface 202 may be or include any interface known in the art for providing two-way communications between a user and telemedicine booth 200. A user may communicate with telemedicine booth 200 in verbal, visual, text entry, or other forms. Telemedicine booth 200 may communicate with a user through an audio, video and/or textual medium. Consequently user interface 202 may include, as illustrated in FIG. 2B one or more of a display screen 202-a, computing device 202-b, telephone 202-c, video camera 202-d, touch-screen 202-e, speaker 202-f, microphone 202-g, keypad 202-h, keyboard 202-i, mouse 202-j, or touchpad 202-k, and other user communications devices, components or systems as known in the art.

Telemedicine booth 200 may use medical parameters capture system 204 to gather one or more of a user's current medical parameters such as for example pulse, blood pressure, or body temperature. To gather the user's medical parameters, medical parameters capture system 204 may include one or more devices or instruments for capture or recording that may be operated by a user with or without guidance or instructions provided via for example user interface 202 or directly by the one or more devices. These devices may include for example a thermometer, weight scale, a blood pressure reader, infra-red imager, vibration sensors, oxygen or carbon dioxide sensors, ECG monitoring device, dermatological camera, pulse oximeter, electronic stethoscope, ultrasound transceiver, and other sensors.

In some embodiments, one or more of the devices in medical parameters capture system 204 may be disposable or single-use, or may require a disposable part such as for example a cover for a thermometer for proper or sanitary operation. Disposable parts or disposables may be stored and supplied directly to the device or to the user by disposables supply 206. After usage, these disposables may require a sanitary disposal device such as, e.g., disposal system 208. Disposal system 208 may be or include any appropriate sanitary receptacle or storage device for proper disposal of the medical disposables provided by disposables supply 206. As part of routine operation of telemedicine booth 110, disposables supply 206 and disposal system 208 may require periodic replenishment and emptying respectively. In some embodiments, the telemedicine booth 200 may measure the quantity of disposable parts remaining in the disposables supply 206 and/or the space remaining in disposal system 208. Indications of the remaining quantity or quantities and/or space may be transmitted remotely to service personnel to facilitate timely replenishment of disposable parts and/or emptying of disposal system 208.

To establish a communications link between telemedicine booth 200 and a routing agent such as routing agent 120, telemedicine booth 200 may include a communications system 210. Communications system 210 may be connected to user interface 202 and medical parameters capture system 204 and other components or systems of telemedicine booth 200 and may include appropriate equipment for the transmission and reception of user data, audio and video signals as known in the art. Communications system 210 may be implemented using, for example, a transmitter, a transceiver, or a transmitter-receiver, or one or more units able to perform separate or integrated functions of transmitting and/or receiving communication signals, blocks, frames, transmission streams, packets, messages and/or data. Communications system 210 may communicate over for example a public network such as a public-switched telephone network and/or the cellular telephone network, a data network such as the Internet, a direct point-to-point fiber link other wired links, wireless links, and/or satellite links. In some embodiments, communications system 210 may be capable of communicating with a medical service provider such as, e.g., medical service provider 130 either directly or through routing agent 120. Furthermore, communications system 210 may be capable of supporting more than one communications link simultaneously.

Payment/authentication system 212 may be or include one or more devices for collecting information identifying the user and payment information. Collecting information identifying the user may be accomplished by for example text entry or audio entry via user interface 202. Alternatively, as illustrated in FIG. 2C, system 212 may include a credit card reader 212-a, identification card reader 212-b, smart card reader 212-c, a radio frequency identification (RFID) reader 212-d, a bar code reader 212-e, universal serial bus (USB) port 212-f that may be used to read a USB key, a fingerprint reader 212-g or other biometric sensor 212-h, or by other collection devices known in the art. In some embodiments, payment/authentication system 212 may use communication system 210 and communication link 160 to connect to database 125 to retrieve a user's records for user authentication or authorization. Payment authorization techniques are well known in the art and may include a separate link such as for example to financial service provider, e.g. a credit card issuing bank. Authenticating or verifying a user's identity and validating the method of payment may occur prior to telemedicine booth 200 establishing a communications link to a routing agent.

During a medical consultation, a medical service provider may prescribe a sample or other sized portion of a medicine to be dispensed in telemedicine booth 200 by medicine dispenser 214. The dispensed medicine may be or include one or more over-the-counter, non-controlled substance medicines such as aspirin. Additionally or alternatively, medicine dispenser 214 may be configured to dispense a limited set of prescription medicines when directed to do so by an appropriately licensed medical service provider. The medication dispenser 214 may be located outside the telemedicine booth 200, such as in a separate cabinet on a nearby wall.

A medical service provider may prescribe a controlled substance medicine not available in medicine dispenser 214 or may provide written care instructions for the user. In these instances, a medical service provider may send a prescription or set of instructions to printer 216 for printing. Printer 216 may be a printing device known in the art for printing documents such as, e.g., general instructions, prescriptions, or receipts. In some embodiments, printer 216 may print on plain paper or one or more forms as appropriate for the prescription or instructions. Printer 216 may also be used to print other documents. In some embodiments, the communications system 210 may send an indication to service personnel that printer 216 needs replenishment.

Referring to FIG. 2D, there is illustrated an example embodiment of a construction of a telemedicine booth 230, shown in cut-away perspective view, according to one example embodiment of the inventive subject matter. Booth 230 includes a housing 230-a, a door 230-b, a ramp 230-c, a touch screen 230d, a tray 230e, a chair or stool 230f, a speaker 230g, a camera 230h, a maintenance and/or equipment compartment 230i, a removable panel 230j used to access compartment 230i, a booth light 230k, and optionally a fan and/or ultraviolet (UV) light 230l mounted in the ceiling. According to one example embodiment, the size and shape of the booth is similar to a photo-booth, where someone enters to have their picture taken. According to another embodiment, booth 230 may be placed in locations where someone may need to talk with a doctor but no doctor is present. For example, booths might be placed in airports, casinos, hotels, and at large events. The booths have an internet connection to a doctor or nurse practitioner that may be at a remote location.

Referring to FIG. 2E, there is illustrated a schematic diagram of a telemedicine booth 240 that includes at least one ultraviolet light 242 and an activation circuit 244. Ultraviolet (UV) light source 242 is selected and adapted to provide sufficient strength of UV light radiation to reduce the growth of or kill bacteria in the patient compartment 241 of booth 240. Booth 240 includes, in one embodiment, the components described with respect to booth 220 and may be sized and designed in the configuration described above with respect to booth 230. In this regard, booth 240 may include a video display, one or more data input devices, a data storage device, and one or more medical data collection instruments to collect one or more measurements of a physiological parameter of a patient using the booth. According to one embodiment, the ultraviolet light source 242 is in the ceiling of the booth, and the activation circuit includes at least one switch to selectively activate the ultraviolet light source. The light source may be activated using the activation circuit when a patient leaves the booth, for example by automatically detecting the booth is not occupied, or by a custodian. In one embodiment, the activation circuit includes an activation switch that is accessed from storage compartment 245, which is not accessible to a patient, preventing the patient from being exposed to potentially harmful levels of UV radiation.

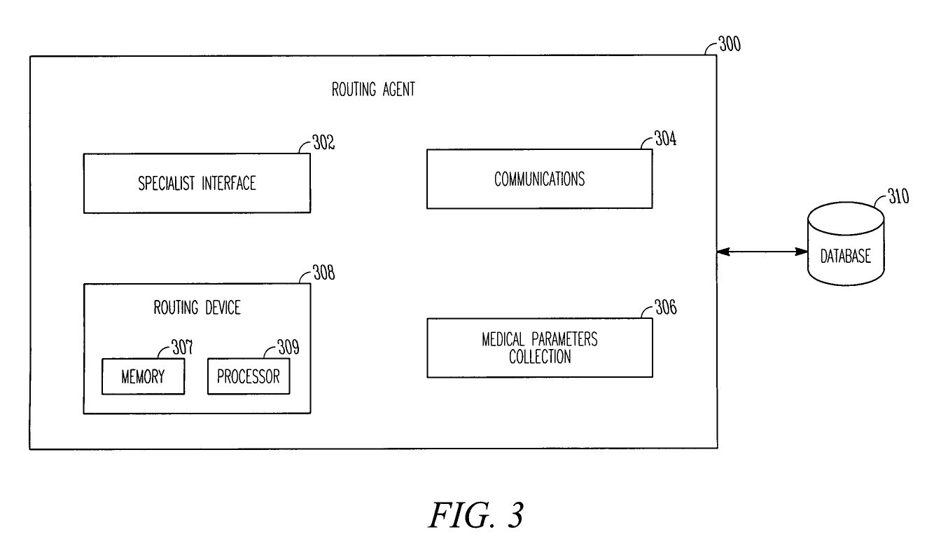

Reference is now made to FIG. 3, depicting a routing agent according to an embodiment of the inventive subject matter. Routing agent 300 may be a call center or other intermediary agent for connecting a user in a telemedicine booth with an appropriate medical service provider. Routing agent 300 may include a specialist interface 302, a communications system 304, medical parameters collection system 306, and a routing device 308 which may include a memory 307 and a processor 309.

In some embodiments, routing agent 300 may require staffing for operation and may include a specialist interface 302 for a call or routing specialist who may or may not be a licensed medical professional. Specialist interface 302 may be or include a terminal, telephone and/or other communications equipment for call specialists known in the art. Alternatively, routing agent 300 may be fully automated.

Routing agent 300 may use communications system 304 to connect with telemedicine booth 110 and a medical service provider 130. In some embodiments, communications system 304 may be capable of establishing separate communications links for telemedicine booth 110 and medical service provider 130 and combining them in a conferencing configuration. Communications system 304 may be capable of establishing a direct link between medical service provider 130 and telemedicine booth 110. Communications system 304 may be connected to specialist interface 302 and medical parameters collection system 306 and other components or systems of routing agent 300 and may include appropriate equipment for the transmission and reception of user data, audio and video signals. Communications system 304 may be implemented using for example a transmitter, a transceiver, or a transmitter-receiver, or one or more units able to perform separate or integrated functions of transmitting and/or receiving communication signals, blocks, frames, transmission streams, packets, messages and/or data. Communications system 304 may communicate over for example a public network such as a public-switched telephony network (and/or a cellular telephone network), a data network such as the Internet, a direct point-to-point fiber link, other wired links, wireless links, and/or satellite links. Furthermore, communications system 304 may be capable of supporting more than one communications link simultaneously.

Medical parameters collection system 306 may be or include a computerized device or system for receiving medical parameters collected by a telemedicine booth such as for example telemedicine booth 200. In some embodiments, medical parameters collection system 306 may interact with medical parameters capture system 204 during the process of capturing a user's medical parameters either under the control of a call routing specialist, semi-autonomously, or autonomously. Once the medical parameters are transferred to routing agent 300, they may be stored in a database such as e.g. database 125 or other memory unit (not shown). These medical parameters may later be sent to a medical service provider for use in the consultation process.

Routing device 308 may be a computerized system or device for receiving a number of inputs regarding a user and available medical service providers and matching one or more medical service providers to the user for a medical consultation. The matching process may be performed by an algorithm or other systematic process employing a number of criteria as parameters; scoring, rating, or prioritizing the parameters; and determining one or more medical service providers with the highest scores or ratings. The various inputs required for the determination may be received by routing device 308 from telemedicine booth 110, by direct entry of a call specialist at specialist interface 302, and/or from one or more databases 125.

The inputs regarding the user may include one or more of the user's identity; location; medical history as retrieved from a database 125; current medical parameters, e.g. body vital signs and symptoms, including those captured by telemedicine booth 110 and described by the user; preferences as to medical service provider such as e.g. gender or first language; prior ratings of medical service providers; contracted for service level; and payment budget or account balance. Other user inputs may also be included. Inputs regarding medical service providers may include one or more of current location, licenses or certifications in the state or country where the user resides or is currently located, availability, personal characteristics such as, e.g., gender or language skills, prior experience with the patient, medical specialty, degree of expertise or licensing, prior ratings, and fees for providing a medical consultation. Other medical service provider inputs may also be included.

The routing algorithm or process may rate or score these inputs and combine them in a weighted averaging or score-boarding or other such calculating process as known in the art for optimizing a match. In some embodiments, the routing algorithm may interpret these criteria as either location based constraints or quality of service constraints. Examples of location based constraints may, for example, include a user's location, a user's symptoms, a medical service provider's location, and a medical service provider's area of expertise. Examples of quality of service constraints may include, for example, severity of a user's symptoms as they relate to a level of urgency, duration of a user's waiting time for service, a user's service plan level, a user's willingness to pay more for faster service, and a user's preferences such as e.g. ratings, gender preference, language, and the like. For both types of constraints, a prioritization scheme may be used that may assign higher weighting or more points to some constraints over others such as, for example, severity of symptoms. Other constraints may be used.

In some embodiments, routing device 308 may be configured to match according to different priorities with different point values assigned to different inputs. For example, in some instances the shortest wait time may be more valued than medical service provider rating or preference. Alternatively, in some instances, routing device 308 may be configured to assign users to the lowest cost medical service provider as the highest priority. Other prioritization schemes may also be used.

Memory unit 309 may include, for example, a Random Access Memory, a Read Only Memory, a Dynamic RAM, a volatile memory, a non-volatile memory, a cache memory, a buffer, a short term memory unit, a long term memory unit, or other suitable memory or storage units. Memory unit 309 may, for example, store data received by routing device 308 such as e.g. user inputs and medical service provider inputs, and/or store other data necessary for carrying out routing operations.

Processor 309 may include, for example, a Central Processing Unit (CPU), a Digital Signal Processor (DSP), a microprocessor, a controller, a chip, a microchip, an Integrated Circuit (IC), or any other suitable multi-purpose or specific processor or controller. Processor 120 may, for example, process data received by routing device 308, and/or perform calculations or other operations in accordance with an embodiment of the inventive subject matter described herein.

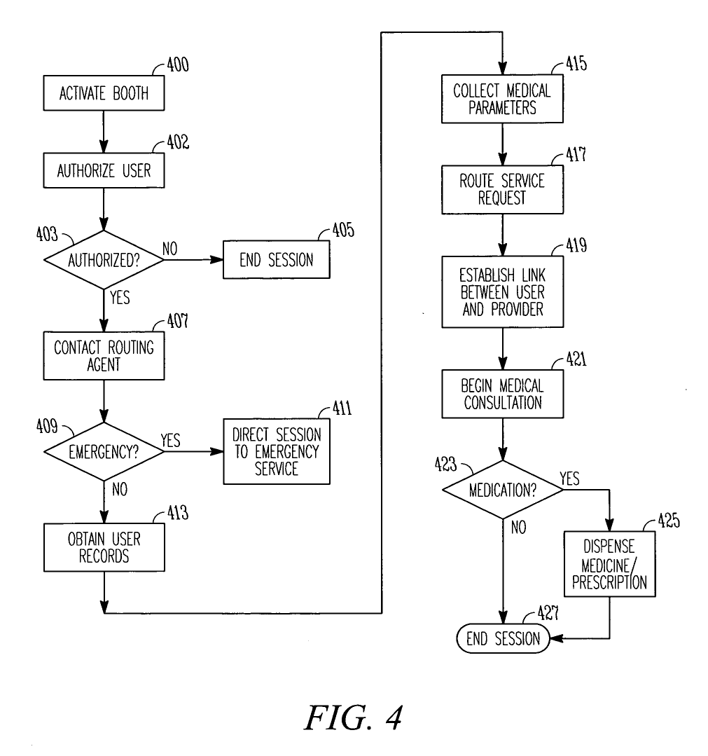

FIG. 4 is a flowchart of a method according to an embodiment of the inventive subject matter. Embodiments may be used by, or may be implemented by, for example, system 100 of FIG. 1 or by other suitable combinations of telemedicine booths, routing agents and medical service providers that may be connected by one or more communications networks. As used herein, the process of a user requesting a medical service, being routed to a medical service provider, and having a medical consultation with a medical service provider may be referred to herein as for example a session A user having a request for medical services may begin the session by entering or accessing a telemedicine station or booth such as e.g. booth 110 and activating the booth in operation 400. Booth activation may be triggered upon entry of the user or by closing a door of the booth or other techniques and may include activating a user interface such as user interface 202. User interface 202 may prompt the user for his identity and/or payment information in operation 401. Additionally, a user may be required to produce evidence of membership in a healthcare service plan such as for example a health maintenance organization (1iMO). In some embodiments, user may be prompted by user interface 202 to slide a membership card, credit card, or smart card in a card reader. In some embodiments, telemedicine booth 110 may contact a routing agent such as routing agent 120 via a communications link such as communications link 140, a database such as database 125 through communications link 160, or other provider for verify a user's identity and payment information.

If a user's identity is not confirmed and/or a payment type is not approved, telemedicine booth 110 may end the session in operation 405. If a user's identity or membership is verified and payment approved (operation 403), telemedicine booth 110 may, in operation 407, contact a routing agent such as routing agent 120 via a communications link such as link 140. In some embodiments, the routing agent may be operated by a call specialist using an interface such as specialist interface 302. The user and the call specialist may be able to communicate over communication link 140 verbally, by text entry, video display and other interactive systems known in the art. in other embodiments a call specialist need not be used.

In operation 409, the call specialist may determine the user's request for medical service is an emergency or the medical condition requires immediate attention. If the request is an emergency, the user may be directed an emergency medical service provider in operation 411 as part of the session or alternatively the session may end.

If the request is not an emergency, the session may continue with operation 413. Routing agent 130 may obtain a user's medical records by retrieving the records from a database, e.g., database 125 and additionally ask the user for further information during the session. Previously stored medical records need not be used and may not be available. The medical records may be used as an input for routing the user's request for medical service and for determining what medical parameters should be collected at telemedicine booth 110.

In operation 415, the call specialist may prompt the user to provide medical parameters from the user's knowledge or by capturing them via for example medical parameters capture system 204. The collection process may be interactive and vary according to the user's status, such as, e.g., apparent symptoms and known conditions, reasons for requesting service, and medical history. In some embodiments, the call specialist may guide or instruct the user through the collection process. Additionally or alternatively, user interface 202 may provide some instructions for collection of certain medical parameters such as e.g. blood pressure. The medical parameters captured by medical parameters capture system 204 may be sent over communications link 140 to medical collection system 306 for subsequent use or possible storage in a database 125, memory 307, or other memory unit not shown.

In operation 417 routing agent 120 may route the user's request for medical service to a medical service provider. The routing may be accomplished using a routing device such as, e.g., routing device 308 which may be operated by a call specialist at specialist interface 302. Routing may be performed algorithmically using a prioritization scheme that may for example assign a point value to each of a number of user and medical service data as inputs. The output of operation 417 may be one or more medical service providers such as medical service provider 130 who may be available for a medical consultation with a user. Other methods of deciding on a provider may be used.

In operation 419, the call specialist may establish a link between the user at telemedicine booth 110 and medical service provider 130. In some embodiments, the call specialist may confirm the availability of a first medical service provider 130 via communication link 150 before connecting medical service provider to telemedicine booth 110. If the first medical service provider 130 is not available or not willing to accept the medical consultation, routing agent 120 may attempt to contact a second medical service provider 130 as selected by routing device 308.

Once the link between telemedicine booth 110 and medical service provider 130 is established, a medical consultation may begin (operation 421). In some embodiments, after routing agent 130 establishes the link between telemedicine booth 110 and medical service provider 130, the call specialist may disconnect from the session, leaving the user and the medical service provider to continue the consultation. In some embodiments the call specialist may, at the medical services provider's request, re-enter the session to finish or continue the session with the user.

The type of link for the medical consultation may be audio only such as for example a telephone call. Alternatively, the link may allow both audio and visual communications such for example by videoconferencing. In some embodiments, the selection of the type of link may be limited to or determined by what medium is available at telemedicine booth 110 and medical service provider 130. Furthermore, the connection between telemedicine booth 110 and medical service provider 130 may be different than their respective connections to routing agent 130. For example, communications with routing agent 130 may occur via telephone link while communications between telemedicine booth 110 and medical service provider 130 may occur via videoconferencing link.

In operation 421, the medical service provider may determine whether the user requires medicine or supplies (e.g., bandages). If the user requires medicine and that medicine is in-stock at telemedicine booth 110, telemedicine booth 110 may dispense the medicine from a medicine dispenser, e.g., medicine dispenser 214 (operation 423). Alternatively, if the medical service provider requests a prescription for the medicine, a printer 216 at telemedicine booth 110 may print the prescription. In some embodiments, the medical service provider 130 may send the prescription electronically or verbally via telephone to a pharmacy. The pharmacy may be chosen based on proximity to the telemedicine booth 110 or to the user. Additional or alternative operations to dispense or prescribe medicine to the user may also be used.

Once the medical consultation is complete, medical service provider 130 or routing agent 120 may terminate the session in operation 427. Medical service provider may return control of the session to a call specialist at routing agent 130 prior to operation 427. Call specialist may route the request for medical services to a second medical service provider such as, e.g., a pharmacy to fill a prescription or to a second, more specialized, medical service provider. Other operations or series of operations may be used. Furthermore, the order or sequence of steps may be modified. For example, some medical parameters may be collected prior to obtaining a user's records and possibly prior to the telemedicine booth contacting the routing agent.

A telemedicine booth, for example as described herein or otherwise devised, may need periodic custodial service. This service may include cleaning of surfaces, such as the seat, floor, walls, and user interface devices such as a touch screen, keyboard, mouse or trackball device. The cleaning is required in order to maintain a pleasant user experience and to minimize spread of communicable disease agents such as viruses or bacteria.

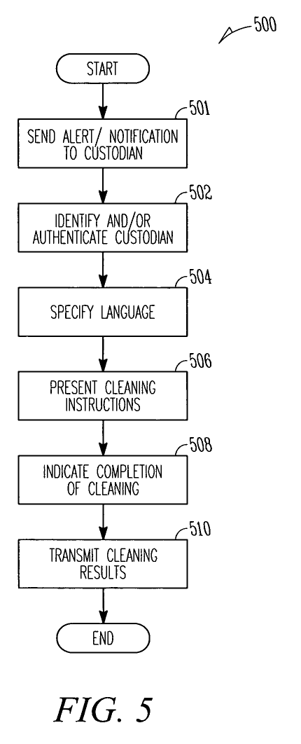

Referring now to FIG. 5, an example embodiment of a method 500 to clean a telemedicine booth is described. According to one embodiment, an optional alert/notification is sent 501 to a custodian that the booth needs or could use cleaning. The custodian may receive this alert/notification 501 and be prompted to go to the booth and perform cleaning operations. Alternatively, no such alert/notification 501 is required. According to another alternative, the alert/notification may be additionally sent to the custodian's supervisor or employer, or any other combination of interested parties. At 502, a cleaning sequence or operation may be initiated by first identifying the custodian, in order to keep a record of which custodian actually cleaned the booth. This may be accomplished, for example, in any number of ways including but not limited to scanning a custodian's identification (ID) badge using a barcode reader (for example reader 212-e), an RFID reader (for example reader 212-d), a USB key using a USB port (for example port 212-f), or by the custodian entering a user name and/or password using one for example a keyboard (such as keyboard 212-i or touch screen 212-e). Alternatively, the custodian may position their face in front of a camera (such as camera 212-d) and recognized and identified by facial recognition software, or the custodian may speak a password phrase into a microphone (such as microphone 212-g) and audio recognition software used to identifies and verify the custodian.

Once the custodian is identified and/or verified (although identification and/verification is optional), a computer in the booth (such as computer 201) provides cleaning instructions through visual and audio prompting 506 for the custodian to guide them through the desired cleaning operations or steps. According to one embodiment, the custodian may be prompted 504 to specify a desired language for the cleaning instructions, such that the cleaning instructions can be provided in two or more different human languages. The cleaning instructions may include, for example, audio or visual prompting provided through the display in the booth (such as the touch screen 212-e) or speakers (such as speakers 212-f). Such instructions may include audio and/or visual instructions such as “Now wipe the screen,” “Now vacuum the floor carpet,” or “Now clean the seat.” The display can also be used to show a video clip on the proper cleaning method.

Following cleaning, the custodian may provide input to the computer to indicate completion 508 of the cleaning operation, either by indicating completion of all cleaning steps or by indicating the completion of each operation or step. The custodian may also indicate if specific areas could not be cleaned. In another embodiment, the booth's camera may be used to take a picture of “dirty” areas of the booth.

Following cleaning, the computer may transmit 510 the results to one or more interested parties or computer systems, such as the custodian's supervisor or employer, the booth's owner or manager, or to a computer system that tracks cleaning and provides reports or other alerts in response to cleaning reports received from the booth. According to one example embodiment, cleaning instructions are stored as digital data, and the data is stored in the data storage device or externally to the telemedicine booth, for example on a server connected to the booth over a network. According to another embodiment, the optional alert/notification is sent to the custodian using a text message (e.g. a SMS message), a telephone call or an e-mail. Such alert/notification may be sent at least in part based on use of the booth or based at least in part on an elapsed time, or a combination thereof.

According to another example embodiment, method 500 may include optionally a patient using the booth to indicate that the booth needs cleaning using at least one of the data input devices. Further, the patient may be solicited to request a cleaning of the booth. If a patient indicates such cleaning is desired, method 500 may provide for sending the alert/notification 501 to the custodian.

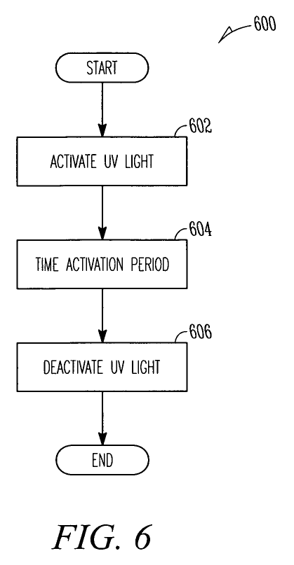

According to another example embodiment 600 illustrated in FIG. 6, at least one ultraviolet light source in the booth is activated 602, kept activated for a period of time 604, and then deactivated 606. The amount of time activated may be selected to reduce the growth of bacteria in the booth or kill bacteria in the booth. According to method 600, the UV light source may be activated by a custodian as part of cleaning the booth, or automatically between patient visits to the booth, for example based on sensors to detect the booth is empty and to assure that the booth door is closed during the cleaning. According to one embodiment, method 600 calls for the custodian to activate the UV light using a switch located on the outside of the booth, for example in a cubby area used to store cleaning supplies, so as to assure that harmful UV radiation cannot be applied to the custodian.

Thus, as described above, the method and apparatus for cleaning a telemedicine booth allow for effective, timely cleaning of the booth, the unambiguous identification of the custodian performing service, the accurate and unambiguous identification of the time employee performed service, and for minimizing the training the custodian needs to perform the cleaning operations.

While the invention has been described with respect to a limited number of embodiments, it will be appreciated that many variations, modifications and other applications of the inventive subject matter may be made. Embodiments of the present invention may include other apparatuses for performing the operations herein. Such apparatuses may integrate the elements discussed, or may comprise alternative components to carry out the same purpose. It will be appreciated by persons skilled in the art that the appended claims are intended to cover all such modifications and changes as fall within the true spirit of the inventive subject matter.

1. Apparatus comprising:
a telemedicine booth including a computer, video display, one or more data input devices, and a data storage device; and
one or more computer programs adapted to execute on the computer to display cleaning instructions on the video display to provide visual instructions regarding acts to be performed to clean the booth.

2. The apparatus according to claim 1 further wherein the booth includes at least one speaker and the cleaning instruction data includes at least one audio prompt or instruction that is presented on the at least one speaker.

3. The apparatus according to claim 1 wherein the booth includes one or more medical data collection instruments to collect one or more measurements of a physiological parameter of a patient using the booth.

4. The apparatus according to claim 1 wherein one of the data input devices is a camera, and the camera captures images of the booth.

5. The apparatus according to claim 1 further including at least one computer program operative on the computer and adapted to:
identify a custodian in the booth;
receive input from the custodian regarding the status of the cleaning performed on the booth;
transmit information regarding the cleaning of the booth to a remote computer system.

6. The apparatus according to claim 1 wherein the cleaning instructions are available in more than one language.

7. The apparatus according to claim 1 farther wherein the one more computer programs are operative on the computer to identify a custodian using any one of the methods selected from the group: scan an identification (ID) badge using a barcode reader in the booth, scan an ID badge using an RFID reader; scan a universal serial bus (USB) key using a USB port, entering an ID value; capturing a picture or video of the custodian and applying facial recognition to identify the custodian, presenting a password or password phrase and using audio recognition to identify the custodian.

8. The apparatus according to claim 1 further wherein the one or more computer programs are further adapted to send an alert/notification to a custodian that the booth needs or could use cleaning.

9. The apparatus according to claim 1 further wherein the one or more computer programs are further adapted to allow a patient using the booth to indicate that the booth needs cleaning using at least one of the data input devices.

10. Apparatus comprising:
a telemedicine booth; and
at least one ultraviolet light source positioned in the telemedicine booth to kill or reduce the growth of bacteria in the booth.

11. The apparatus according to claim 10 wherein the ultraviolet light source is in the ceiling of the booth.

12. The apparatus according to claim 10 including an activation circuit to selectively activate the ultraviolet light source.

13. The apparatus according to claim 12 wherein the light source is activated using the activation circuit when a patient leaves the booth or by a custodian.

14. The apparatus according to claim 13 wherein the activation circuit includes an activation switch that is accessed from outside of the booth.

15. The apparatus according to claim 14 wherein the activation switch cannot be accessed by a patient using the booth.
